(19) United States
(12) Patent Application Publication
(10) Pub. No.: US 2004/0144938 A1
(43) Pub. Date: Jul. 29, 2004

(54) Pressure compensated pilot operated check valve

(76) Inventor: Frank Akselberg, Sandnes (NO)

Correspondence Address: MOSER, PATTERSON & SHERIDAN, L.L.P., 3040 POST OAK BOULEVARD, SUITE 1500, HOUSTON, TX, 77056-6582, US

(21) Appl. No.: 10/686,985

(22) Filed: Oct. 16, 2003

(30) Foreign Application Priority Data
Oct. 17, 2002 (NO) 20024992

(51) Int. Cl. F16K 31/143

(52) U.S. Cl. 251/63.6

(57) ABSTRACT

A pilot operated check microvalve comprises a valve body, a valve seat, and a valve actuator arranged to displace the valve body from the closed position thereof against the valve seat. The area of the valve seat and the portion of the area of the pilot actuator affected in an axial direction by the fluid flowing through the valve seat are substantially the same.

### BACKGROUND OF THE INVENTION

1. Field of the Invention

The present invention relates to a pressure compensated pilot operated check valve. In particular, although not exclusively, it relates to a check microvalve of the kind suitable for a use in downhole tool in connection with petroleum recovery.

2. Description of the Related Art

In the art of valves, microvalves represent a group of their own, adapted to applications where, for example, there is restricted space, or where the weight of the valve is critically for the operation of the device.

Microvalves typically have an external housing diameter of less than 10 mm, inside which are arranged known valve bodies such as valve slides, springs and gaskets. However, the housing diameter may be larger than 10 mm depending on the use or application of the microvalve.

It is clear that known constructions of valves having ordinary dimensions cannot simply be scaled down for use in microvalves. For instance, the components included in the microvalve may have to be adapted in order to allow them to be diminished or mounted. It may also not be economical to manufacture known valve components having the necessary dimensions, and therefore new solutions have to be developed.

Known pilot operated check microvalves suffer from the disadvantage that the operation of opening and closing the microvalve may be adversely affected by the pressure within the valve outlet port. In particular, this may result in the unwanted closing of the valve. The unstable valve operation is caused by insufficient pressure compensation within the valve. This problem is described in greater detail hereinbelow.

### SUMMARY OF THE INVENTION

The present invention generally provides a pilot operated check valve comprising a valve body, a valve seat, and a pilot actuator arranged to displace the valve body from the closed position thereof against the valve seat, whereby the area of the valve seat and the portion of the area of the pilot actuator affected in an axial direction by the fluid flowing through the valve seat are substantially the same. A pressure compensation is thus achieved which prevents, inter alia, improper closing of the valve just after it has been opened. The valve is preferably a microvalve.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a sectional view of a pressure compensated pilot operated check microvalve mounted in a valve block.

FIG. 2 is a larger scale sectional view of the check valve of FIG. 1 in a closed position.

FIG. 3 is a sectional view of the check valve of FIG. 2 in an open position.

FIG. 4 is a simplified diagram of connections wherein the check valve of FIG. 1 is used to guide a working actuator.

### DETAILED DESCRIPTION OF THE PREFERRED EMBODIMENT

In a preferred embodiment the part of the pilot actuator affecting the valve body is formed by a pilot piston rod being displaceably and sealingly disposed in the housing of the pilot operated check microvalve, whereby the fluid pressure within the check valve outlet port is prevented from affecting the pilot piston of the pilot actuator.

The advantageous effect is achieved because the pilot piston rod is exposed to substantially the same fluid force before and after the valve body moves to open the valve.

Some preferred embodiments of the invention will now be described by way of example only and with reference to the accompanying drawings, in which:

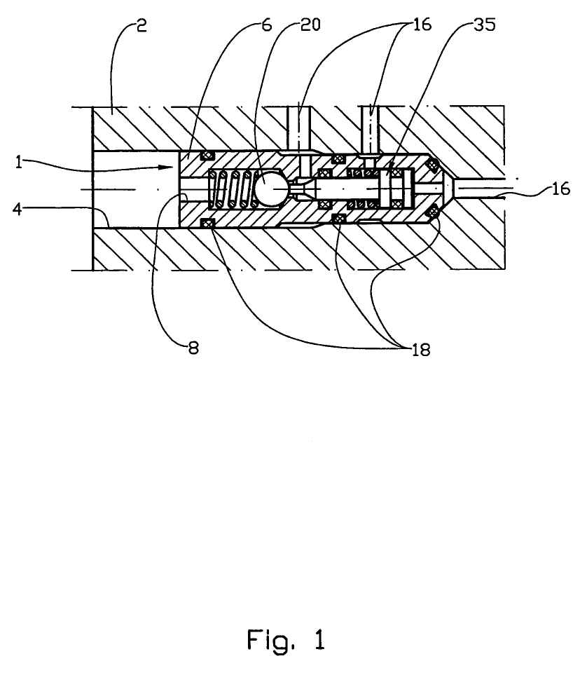

FIGS. 1, 2 and 3 show a compensated pilot operated check valve 1 mounted in a valve block 2. The check valve 1 is disposed in a bore 4 within the valve block 2, the bore 4 also forming a supply opening for pressurised fluid.

The check valve 1 includes a housing 6 provided with an inlet port 8, an outlet port 10, a pilot port 12, and a draining port 14. The valve block 2 is provided with bores 16 corresponding to the ports of the housing 6. Externally surrounding the housing 6 are arranged gaskets 18 between the ports 8, 10, 12, 14 which prevent the pressurised fluid from flowing between the housing 6 and bore 4.

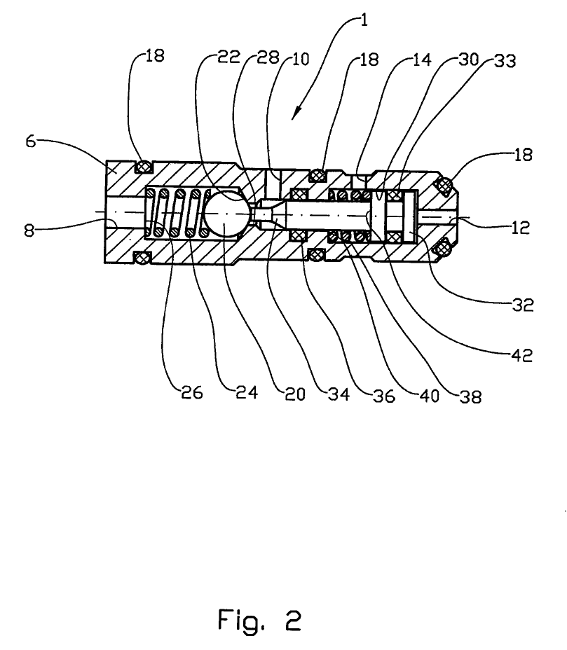

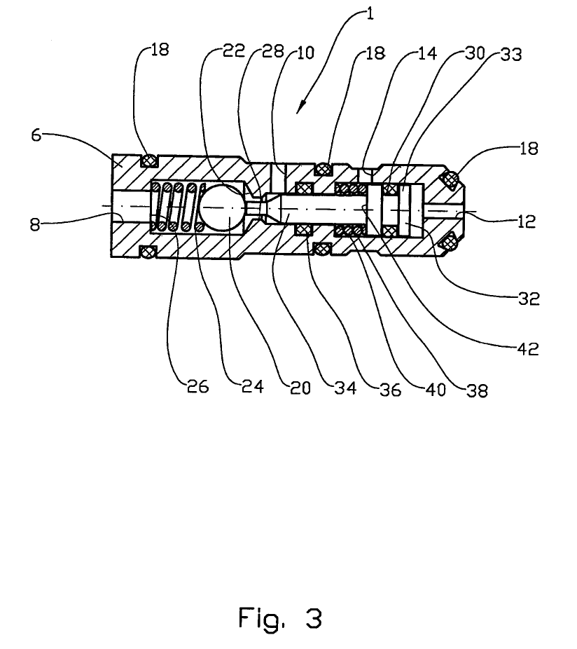

A valve body 20 in the form of a ball is disposed in the valve inlet port 8 and is held against a valve seat 22 by a valve spring 24 restrained between the valve body 20 and a shoulder 26 in the inlet port 8, as shown in FIG. 2. When the check valve 1 is opened, as shown in FIG. 3, fluid can flow past the valve body 20 via a central seat bore 28 arranged between the inlet port 8 and outlet port 10.

In the other end of the housing 6 there is arranged a pilot bore 30 communicating with the pilot port 12. A pilot piston 32 is sealingly arranged by means of a piston gasket 33 displaceably disposed in the pilot bore 30. A piston rod 34 depending from the pilot piston 32 projects into the seat bore 28, so that the end is located proximate the valve body 20 when the valve is in the closed position. The pilot piston 32, pilot piston rod 34, along with the pilot bore 30 form a pilot actuator 35.

A piston rod gasket 36 forms a seal between the pilot piston rod 34 and housing 6. The pilot piston 32 is displaced to an inactive position by a pilot spring 38 surrounding the pilot piston rod 34 and extending between a shoulder 40 within the pilot bore 30 and an annular area 42 of the pilot piston 32 facing the pilot piston rod 34.

The draining port 14 communicates with the pilot bore 30 between the pilot piston gasket 33 and piston rod gasket 36.

The check valve 1 opens automatically when the pressure within the outlet port 10 is sufficiently high relative to the pressure within the inlet port 8, enabling the force provided by the valve spring 26 to be overcome.

When the check valve 1 is closed, the fluid pressure within the inlet port 8 causes the valve body 20 to be pushed against the valve seat 22 as the part of the area of the valve body 20 communicating with the seat bore 28 is relieved, when the outlet port is relieved.

When the check valve 1 is to be opened for fluid passage from the inlet port 8 into the outlet port 10, a pilot pressure is imparted via the pilot port 12 against the pilot piston 32. The pilot pressure overcomes the force of the pilot spring 38 and displaces the pilot piston 32 until the pilot piston rod 34 engages the valve body 20. The pilot pressure is then increased until the closing force of the valve body is also surmounted, whereafter the valve body 20 is displaced to the open position shown in FIG. 3.

The axial cross-sectional area of the pilot piston rod 34 is approximately equal to the area of the valve seat. As a result, the pilot piston 32 is prevented from being displaced to the inactive position by the sudden pressure increase which occurs within the outlet port 10 as the valve body 20 opens.

This situation can be explained by the fact that sufficient pressure must be applied to the pressurised side of the pilot piston 32 to surmount the forces provided by both springs 24 and 28 together with the force provided by the fluid pressure within the inlet port 8 multiplied by the valve seat area. After the valve body 20 has been lifted off the valve seat 22 the pilot piston has to surmount substantially the same spring forces, together with fluid pressure from the inlet port 8 now acting on the sectional area of the pilot piston rod 34, disregarding minor pressure drops across the valve seat 22. The piston gasket 36 prevents the pressure fluid from affecting the annular area 42 of the pilot piston 32.

The pilot piston 32 and pilot piston rod 34 are formable from any configuration of the element to be affected by the pilot pressure performing an opening force against the valve body 20.

The gasket 36 prevents fluid within the outlet port 10 from flowing towards the annular area 42 and applying force to the back of the pilot piston 32, which would cause a change in the forces applied to the pilot piston before and after opening the valve body 20.

By selecting an appropriate piston diameter of the pilot piston 32, a pilot pressure substantially lower than that of the pressure within the inlet port 8 may be utilized to open the check valve 1 by means of a device according to the invention.

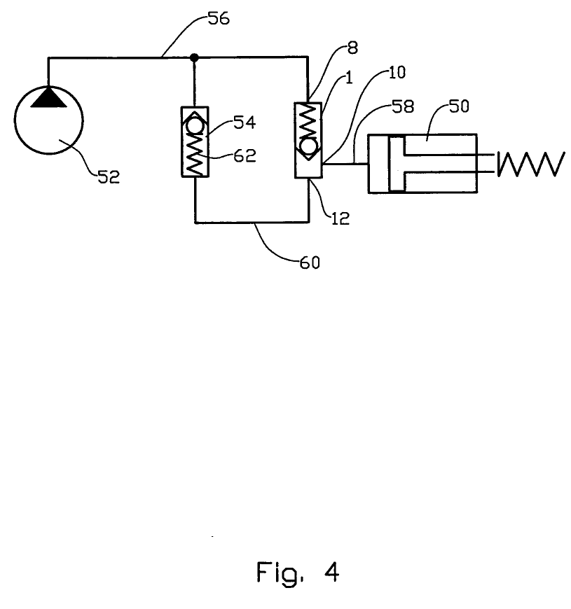

In FIG. 4 the check valve 1 is shown by a simplified diagram of connections supplying the pressurised fluid into a working actuator 50. From a pump 52 pressurised fluid having a relatively high pressure is supplied via a tube 56 into a pressure relief valve 54 and the inlet port 8 of the check valve 1. The check valve 1 opens for fluid passage via the outlet port 10 and a tube 58 into the actuator 50, when the pressure within a pilot tube 60 connecting the pressure relief valve 54 to the pilot port 12 has been increased to a level at which the fluid pressure towards the pilot piston 32 surmounts the spring and closing forces, as described above.

The pressure drop within the pressure relief valve is determined by the strength of a closing spring 62 in the pressure relief valve 54.

While the foregoing is directed to embodiments of the present invention, other and further embodiments of the invention may be devised without departing from the basic scope thereof, and the scope thereof is determined by the claims that follow.

1. A pilot operated check valve, comprising:
a valve body;
a valve seat; and
a pilot actuator arranged to displace the valve body from a closed position, wherein an area of the valve seat and an area of a portion of the pilot actuator acted on in an axial direction by fluid flowing through the valve seat are substantially the same.

2. The pilot operated check valve of claim 1, wherein the pilot actuator comprises a pilot piston rod displaceably and sealingly disposed in a housing of the valve to act on the valve body.

3. The pilot operated check valve of claim 1, wherein a gasket sealingly disposes a pilot piston rod of the pilot actuator in a housing of the valve, the pilot piston rod for acting on the valve body.

4. The pilot operated check valve of claim 1, wherein the valve is a microvalve.

5. The pilot operated check valve of claim 1, further comprising a valve spring that biases the valve body against the valve seat.

6. The pilot operated check valve of claim 1, further comprising a pilot spring that biases the pilot actuator away from the valve body.

7. The pilot operated check valve of claim 1, further comprising:
a valve spring that biases the valve body against the valve seat; and
a pilot spring that biases the pilot actuator away from the valve body.

8. The pilot operated check valve of claim 1, further comprising a valve block surrounding the check valve.

9. The valve of claim 1, wherein the valve body is a ball.

10. A valve, comprising:
a housing having an inlet port, an outlet port, and a pilot port therein;
a valve seat disposed between the inlet port and the outlet port;
a valve body that selectively displaces from the valve seat; and
a pilot actuator having a rod coupled to a piston, wherein the rod selectively displaces the valve body, and wherein the piston has a larger sectional area than the rod, the piston having a surface for receiving a fluid pressure supplied via the pilot port.

11. The valve of claim 10, wherein a gasket sealingly disposes the rod of the pilot actuator in the housing of the valve.

12. The valve of claim 10, wherein an area of the valve seat and an area of the rod acted on by fluid flowing through the valve seat are substantially the same.

13. The valve of claim 10, wherein the housing further comprises a pilot drain that drains a portion of a pilot bore located between the piston of the pilot actuator and a gasket surrounding the rod of the pilot actuator.

14. The valve of claim 10, further comprising a valve spring that biases the valve body against the valve seat.

15. The valve of claim 10, further comprising a pilot spring that biases the pilot actuator away from the valve body.

16. The valve of claim 10, further comprising:
a valve spring that biases the valve body against the valve seat; and
a pilot spring that biases the pilot actuator away from the valve body.

17. The valve of claim 10, wherein the valve body is a ball.

18. An assembly for operating an actuator with a microvalve, comprising:
a pump in fluid communication with an inlet of the microvalve;
a pilot actuator disposed within the microvalve, the pilot actuator having a first portion for acting on a valve body of the microvalve to move the valve body;
a pressure relief valve disposed in a fluid pathway between the pump and a second portion of the pilot actuator, the pressure relief valve opens at a predetermined pressure thereby operating the pilot actuator; and
an outlet of the microvalve in fluid communication with the actuator for operating the actuator.

19. The assembly of claim 18, wherein the first portion of the pilot actuator has a smaller sectional area than the second portion of the pilot actuator.

20. The assembly of claim 19, wherein a gasket disposed around the rod isolates fluid pressure between the first portion and the second portion of the pilot actuator.
